(19) United States
(12) Patent Application Publication
(10) Pub. No.: US 2015/0202852 A1
(43) Pub. Date: Jul. 23, 2015

(54) METHOD AND APPARATUS FOR MANUFACTURING COMPOSITE MATERIAL

(71) Applicants: Yoichi MIYAGAWA, Miyoshi-shi (JP); Daijiro KIKUCHI, Toyota-shi (JP)

(72) Inventors: Yoichi MIYAGAWA, Miyoshi-shi (JP); Daijiro KIKUCHI, Toyota-shi (JP)

(73) Assignees: TSUCHIYA CO., LTD., Nagoya-shi (JP); TOYOTA JIDOSHA KABUSHIKI KAISHA, Toyota-shi (JP)

(21) Appl. No.: 14/598,985

(22) Filed: Jan. 16, 2015

(30) Foreign Application Priority Data
Jan. 22, 2014 (JP) 2014-009606

(51) Int. Cl. B32B 37/10; B32B 37/06; B32B 38/18; B32B 37/00

(52) U.S. Cl. CPC B32B 37/1009; B32B 37/0046; B32B 37/06; B32B 38/18

(57) ABSTRACT

A method for manufacturing a composite material includes the processes of: arranging a surface material in a chamber box; dividing the chamber box into a first space including the surface material arranged therein and a second space including a core member arranged therein by closing a dividing unit; heating the surface material; arranging the core member in the second space while the surface material is being heated; depressurizing the first space and the second space; opening the dividing unit to make the first space communicate with the second space, arranging the core member and the surface material relatively close to each other, and covering a predetermined part of the core member with the surface material; and pressurizing the chamber box to bond the surface material to the predetermined part of the core member so that the surface material fits the predetermined part of the core member.

### INCORPORATION BY REFERENCE

This application is based upon and claims the benefit of priority from Japanese patent application No. 2014-9606, filed on Jan. 22, 2014, the disclosure of which is incorporated herein in its entirety by reference.

### BACKGROUND OF THE INVENTION

1. Field of the Invention

The present invention relates to a method and an apparatus for manufacturing a composite material, and in particular, to a method and an apparatus for manufacturing a composite material by bonding a surface material to a core member.

2. Description of Related Art

A composite material in which a surface material such as a plastic sheet is bonded to a core member made of, for example, synthetic resin has been used for vehicles, electrical appliances, etc. Such a composite material may be manufactured using a manufacturing apparatus disclosed in, for example, Japanese Unexamined Patent Application Publication No. 2005-262501.

The manufacturing apparatus disclosed in Japanese Unexamined Patent Application Publication No. 2005-262501 includes a chamber box including a core member and a surface material arranged therein, pressure in the chamber box being adjustable, an upper lid that opens or closes a part through which the surface material and the core member is taken into the chamber box; a heating part that heats the surface material; and a drive unit that lowers the surface material.

The composite material is manufactured by such a manufacturing apparatus as shown in the flow of a method for manufacturing the composite material in the upper part of FIG. 8. First, the upper lid is opened and the core member is arranged inside the chamber box from the part through which the chamber box is taken into. Next, the surface material is arranged near the part through which the chamber box is taken into and the upper lid is closed, and the chamber box is brought to a vacuum state while the surface material is being heated by the heating part.

The surface material is then lowered by the drive unit and a predetermined part of the core member (a part of the core member to be covered with the surface material) is covered with the surface material. Next, the pressure in the chamber box is brought back to atmospheric pressure, the surface material is bonded to fit the predetermined part of the core member, and the composite material in which the surface material is bonded to the core member is retrieved.

When the composite material as stated above is being manufactured, the processes for arranging the core member and heating the surface material are time-consuming processes. However, since the manufacturing apparatus disclosed in Japanese Unexamined Patent Application Publication No. 2005-262501 carries out the process for arranging the core member and the process for heating the surface material in one space in the chamber box, it is impossible to have the process for arranging the core member and the process for heating the surface material, which are the most time-consuming processes when the composite material is being manufactured, overlap in time. It therefore takes time to manufacture the composite material.

### SUMMARY OF THE INVENTION

The present invention has been made in view of the above background, and aims to provide a method and an apparatus for manufacturing a composite material in a short period of time.

A method for manufacturing a composite material according to one aspect of the present invention is a method for manufacturing a composite material by covering a core member with a surface material heated in a chamber box under reduced pressure, pressurizing the chamber box, and bonding the surface material to the core member, the method including the processes of: arranging the surface material in the chamber box; dividing the chamber box into a first space and a second space by closing a dividing unit, the first space including the surface material arranged therein and the second space including the core member arranged therein; heating the surface material; arranging the core member in the second space while the surface material is being heated; depressurizing the first space in which the surface material is arranged and the second space in which the core member is arranged; after the first space and the second space are depressurized, opening the dividing unit to make the first space communicate with the second space, arranging the core member and the surface material relatively close to each other, and covering a predetermined part of the core member with the surface material; and after the predetermined part of the core member is covered with the surface material, pressurizing the chamber box to bond the surface material to the predetermined part of the core member so that the surface material fits the predetermined part of the core member.

According to the above configuration, the space is divided into the first space and the second space, whereby the core member can be arranged in the second space while the surface material is being heated in the first space. The process for heating the surface material and the process for arranging the core member, which cannot be conventionally overlapped in time, can be overlapped in time. It is therefore possible to manufacture the composite material in a short period of time.

It is preferable in the method for manufacturing the composite material that depressurization of the first space be started while the surface material is being heated.

According to the above configuration, it is possible to have more time to depressurize the first space than in the case in which the first space is depressurized at the same time that the second space is depressurized. It is therefore possible to reduce the size of the pressure adjusting part in the first space and to form the pressure adjusting part at a low cost.

It is preferable in the method for manufacturing the composite material to include a process for heating the core member before the second space is depressurized.

According to the above configuration, the core member can be heated, whereby the adhesiveness between the surface material and the core member can further be improved.

An apparatus for manufacturing a composite material according to one aspect of the present invention is an apparatus for manufacturing a composite material by covering a core member with a surface material heated in a chamber box under reduced pressure, pressurizing the chamber box, and bonding the surface material to the core member, the apparatus including: a dividing unit that opens or closes a first communication path between a first space and a second space so that the chamber box can be divided into the first space and the second space, the first space containing the surface material and pressure in the first space being adjustable, the second space containing the core member and pressure in the second space being adjustable.

According to the above configuration, the space is divided into the first space and the second space, whereby the core member can be arranged in the second space while the surface material is being heated in the first space. The process for heating the surface material and the process for arranging the core member, which cannot be conventionally overlapped in time, can be overlapped in time. It is therefore possible to manufacture the composite material in a short period of time.

It is preferable in the apparatus for manufacturing the composite material that the apparatus includes: a first heating part arranged in one side of the surface material in the first space; and a second heating part arranged in the dividing unit and arranged in another side of the surface material in the first space in a state in which the dividing unit closes the first communication path, and in which the surface material is heated by the first heating part and the second heating part from both sides of the surface material.

It is therefore possible to heat the surface material by the first heating part and the second heating part in such a way that the surface material is held between the first heating part and the second heating part, whereby the surface material can be heated in a short period of time.

It is preferable in the apparatus for manufacturing the composite material that the apparatus includes: a fixing unit arranged in the first space and fixing a circumferential edge of the surface material, in which the fixing unit includes a second communication path that communicates one space and another space with the surface material interposed therebetween in the first space.

According to the above configuration, when the pressure is adjusted in a space on one side of the surface material, the pressure in a space on the opposite side thereof is also adjusted. It is therefore possible to adjust the pressure in the first space with a smaller number of pressure adjusting parts.

It is preferable in the apparatus for manufacturing the composite material to include a third heating part that heats the core member.

According to the above configuration, the core member can be heated, whereby the adhesiveness between the surface material and the core member can be further improved.

It is preferable in the method for manufacturing the composite material that the third heating part feed hot air to the second space and sucks out gas in the second space.

It is therefore possible to take out dust and the like suspended in the second space together with gas. According to the above configuration, hardly any dust penetrates between the surface material and the core member, whereby it is possible to manufacture the composite material with high accuracy.

According to the present invention, it is possible to manufacture the composite material in a short period of time.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIGS. 1 to 6 are schematic diagrams showing processes of a method for manufacturing a composite material according to a first embodiment;

FIG. 7 is an oblique view schematically showing a state in which a surface material is fixed by a fixing unit;

FIG. 8 shows in an upper part thereof a diagram showing a flow of a method for manufacturing a composite material according to a related art and shows in a lower part thereof a diagram showing a flow of the method for manufacturing the composite material according to the first embodiment; and

FIG. 9 is a schematic view showing a process for manufacturing a composite material using an apparatus for manufacturing a composite material according to a second embodiment.

### DESCRIPTION OF THE EXEMPLARY EMBODIMENTS

Hereinafter, with reference to the drawings, specific embodiments of the present invention will be described in detail. Note that the present invention is not limited to the following embodiments. Further, for the sake of clarification of the description, the following description and the drawings are simplified as appropriate.

### First Embodiment

Hereinafter, an apparatus and a method for manufacturing a composite material according to this embodiment will be described. First, the apparatus for manufacturing the composite material according to this embodiment (hereinafter may be simply abbreviated as a manufacturing apparatus) will be schematically described. The manufacturing apparatus may be used, for example, when a composite material is manufactured in which a surface material such as a plastic sheet is bonded to a core member made of, for example, synthetic resin used for vehicles, electrical appliances, etc.

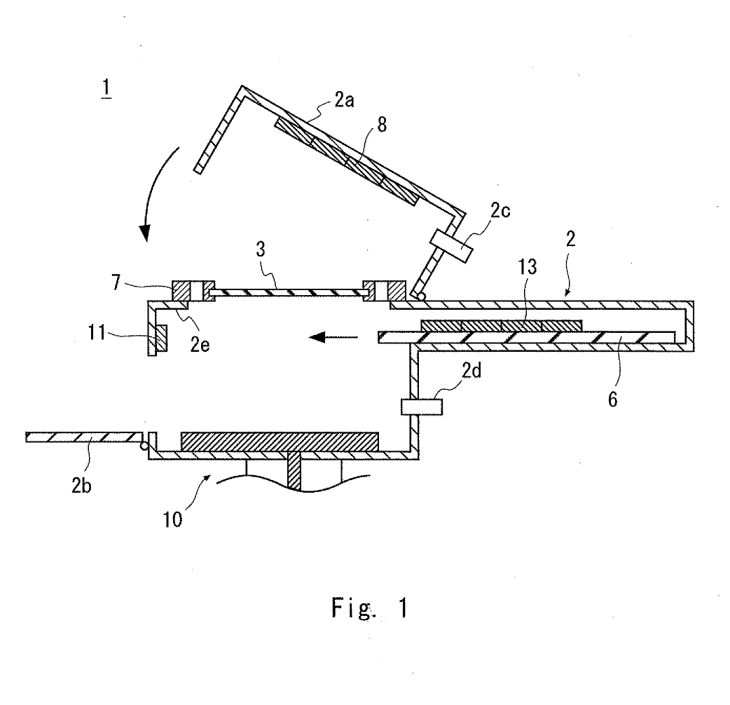

FIGS. 1 to 6 are schematic diagrams showing processes of the method for manufacturing the composite material (hereinafter may be simply abbreviated as a manufacturing method) according to this embodiment, and with reference to FIGS. 1 to 6, a manufacturing apparatus 1 will be described.

As shown in FIGS. 1 to 6, in the manufacturing apparatus 1, a surface material 3 that is heated and a core member 4 are arranged relatively close to each other in a chamber box 2 under reduced pressure to cover the core member 4 with the surface material 3, and thereafter the chamber box 2 is pressurized and the surface material 3 is bonded to the core member 4, thereby manufacturing a composite material 5.

The manufacturing apparatus 1 according to this embodiment includes a dividing unit 6 that opens or closes a communication path between a first space S1 and a second space S2 so that the chamber box 2 can be divided into the first space S1 and the second space S2. The first space S1 contains the surface material 3 and the pressure in the first space S1 can be adjusted, and the second space S2 contains the core member 4 and the pressure in the second space S2 can be adjusted.

While the details of the manufacturing apparatus will be described later, according to the above configuration, the chamber box is divided into the first space S1 and the second space S2, whereby it is possible to arrange the core member 4 in the second space S2 while the surface material 3 is heated in the first space S1. It is therefore possible to overlap the process for heating the surface material 3 with the process for arranging the core member 4 in time, which is not achieved by the related art. It is therefore possible to manufacture the composite material 5 in a short period of time.

Next, the manufacturing apparatus 1 will be described in detail. The manufacturing apparatus 1 includes a chamber box 2, a dividing unit 6, a fixing unit 7, a first heating part 8, a jig 9, and a drive unit 10.

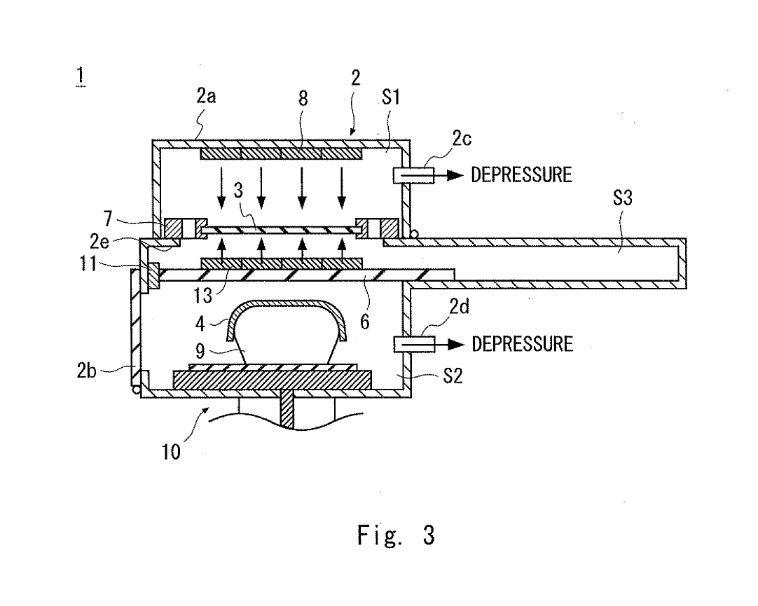

The chamber box 2 includes, as described above, the first space S1 in which the surface material 3 is contained and the second space S2 in which the core member 4 is contained. In the chamber box 2 according to this embodiment, as shown in FIG. 3, for example, the first space S1 is arranged above the dividing unit 6 and the second space S2 is arranged below the dividing unit 6. The chamber box 2 according to this embodiment includes a third space S3 that contains the dividing unit 6 near the communication path of the first space S1 and the second space S2.

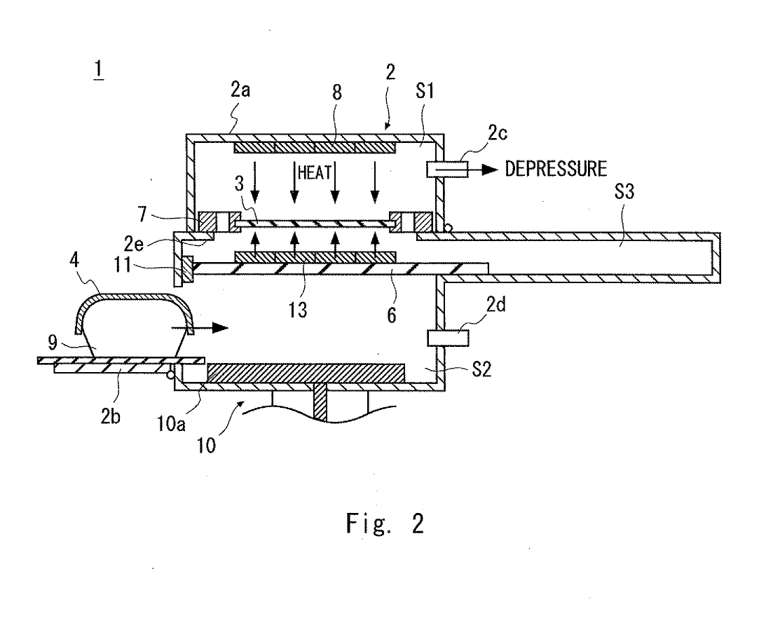

The chamber box 2 includes a first cover part 2a in the upper part thereof. As shown in FIG. 1, when the first cover part 2a is opened, the upper part of the first space S1 is opened, and this opened part serves as a part through which the surface material 3 is taken into the chamber box 2 and a part through which the composite material 5 is taken out of the chamber box 2. Further, the chamber box 2 includes a second cover part 2b in the lower part thereof that can be opened or closed. As shown in FIG. 2, when the second cover part 2b is opened, the side part of the second space S2 is opened, and this part serves as a part through which the core member 4 is taken into the chamber box 2. While the first cover part 2a and the second cover part 2b according to this embodiment can be opened or closed by hinges, they may be of a slide type instead.

The first space S1 is substantially closed in a state in which the chamber box 2 is divided by the dividing unit 6 and the first cover part 2a is closed. The first space S1 is connected to a first pressure adjusting part (not shown) including a valve or a pump through a first inlet/outlet 2c formed in the chamber box 2 so that the pressure in the first space S1 can be adjusted.

The second space S2 is substantially closed in a state in which the chamber box 2 is divided by the dividing unit 6 and the second cover part 2b is closed. The second space S2 is connected to a second pressure adjusting part (not shown) including a valve or a pump through a second inlet/outlet 2d formed in the chamber box 2 so that the pressure in the second space S2 can be adjusted. According to the above configuration, the first space S1 and the second space S2 are separately brought to a substantially vacuum state and an atmospheric pressure state.

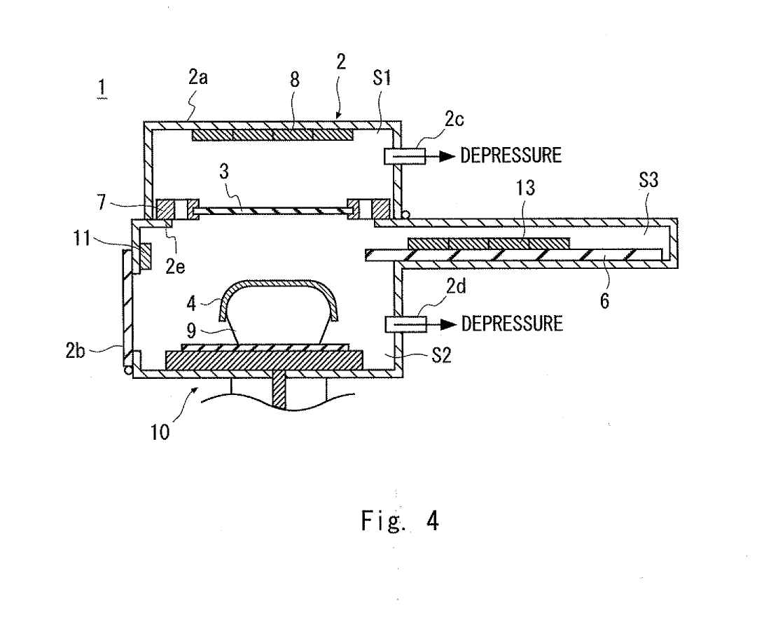

The dividing unit 6 opens or closes the communication path between the first space S1 and the second space S2. The dividing unit 6 according to this embodiment is a plate-like member that can be slid by a drive unit (not shown) in the horizontal direction, and as shown in FIGS. 3 and 4, for example, closes the communication path between the first space S1 and the second space S2 when it is slid in one direction and is contained in the third space S3 of the chamber box 2 when it is slid in the other direction.

The dividing unit 6 is preferably made of a material that is hardly deformed when the pressure in the first space S1 or the second space S2 is adjusted, and is made of, for example, metal. Further, it is preferable that a packing 11 be provided in an inner side surface of the chamber box 2 so as to prevent occurrence of a gap between an end part of the dividing unit 6 on the side of a sliding direction and the chamber box 2 when the dividing unit 6 is slid in one direction. It is preferable that the packing 11 be made of a material that is adequately deformed when the end part of the dividing unit 6 is brought into contact with the packing 11 and comes into intimate contact with the end part of the dividing unit 6, and is made of, for example, synthetic resin such as rubber.

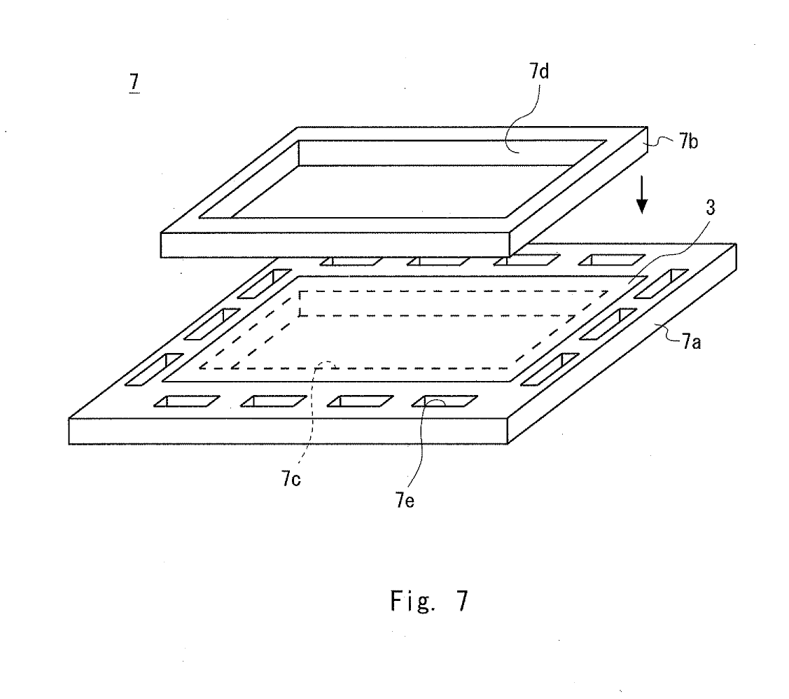

The fixing unit 7 fixes the circumferential edges of the surface material 3. FIG. 7 is an oblique view schematically showing the state in which the surface material 3 is fixed by the fixing unit 7. As shown in FIG. 7, the fixing unit 7 includes a frame member 7a, a pressing member 7b and the like.

The frame member 7a includes an opening part 7c so that the part of the surface material 3 bonded to the core member 4 is exposed when seen from the vertical direction, and the surface material 3 is loaded on the upper surface of the frame member 7a. This frame member 7a is supported by a support member 2e which protrudes from the inner side surface in the first space S1, and is arranged above the dividing unit 6 in a state in which the dividing unit 6 divides the chamber box 2 into the first space S1 and the second space S2. The surface material 3 is made of a plastic sheet as stated above, and adhesive is applied to the surface of the surface material 3 bonded to the core member 4.

The pressing member 7b includes an opening part 7d so that the part of the surface material 3 bonded to the core member 4 is exposed when seen from the vertical direction, and sandwiches the circumferential edges of the surface material 3 loaded on the frame member 7a together with the frame member 7a. At this time, the opening part 7c of the frame member 7a and the opening part 7d of the pressing member 7b are arranged substantially at the same position when seen from the vertical direction. This pressing member 7b is fixed to the frame member 7a by a clamp (not shown) in a state in which the pressing member 7b sandwiches the circumferential edges of the surface material 3 together with the frame member 7a.

Note that, in the state in which the fixing unit 7 that fixes the surface material 3 is supported by the support member 2d of the first space S1, the first space S1 is divided into upper and lower spaces by the surface material 3 and the like. Therefore, in order to uniformly adjust the pressure of the first space S1, it is required to provide pressure adjusting parts to adjust the pressure in the upper and lower spaces.

It is preferable, as shown in FIG. 7, that the frame member 7a include a communication path 7e that communicates the upper and lower spaces divided by the surface material 3 and the like. According to the above configuration, when the pressure in one of the upper and lower spaces is adjusted, the pressure in the other space is adjusted as well. It is therefore possible to adjust the pressure in the first space S1 with a smaller number of pressure adjusting parts.

The first heating part 8 is arranged in the first space S1 and heats the surface material 3. The first heating part 8 according to this embodiment is provided, as shown in FIG. 2, for example, on the inner upper surface of the first cover part 2a of the chamber box 2 so as to face the upper surface of the surface material 3.

Since the process for heating the surface material 3 is the time-consuming process when the composite material is manufactured, as described above, it is preferable to efficiently heat the surface material 3. It is thus preferable that a second heating part 13 be provided on the upper surface of the dividing unit 6. According to this configuration, when the chamber box 2 is divided into the first space S1 and the second space S2 by the dividing unit 6, the second heating part 13 is arranged below the surface material 3. It is therefore possible to heat the surface material 3 in such a way as to vertically sandwich the surface material 3 by the first heating part 8 and the second heating part 13, whereby the surface material 3 can be heated in a short period of time.

The jig 9 supports the core member 4. The jig 9 according to this embodiment is taken into the drive unit 10 from outside through the part via which the core member 4 is taken into the chamber box 2 by a transporting unit (not shown) or taken outside from the drive unit 10 through the part via which the core member 4 is taken out of the chamber box 2. Note that the jig 9 is appropriately changed according to the shape of the core member 4.

The drive unit 10 relatively moves the surface material 3 and the core member 4. The drive unit 10 according to this embodiment includes a stage 10a and an actuator 10b connected to the stage 10a, and is arranged immediately below the surface material 3. The actuator 10b is driven in the vertical direction. It is therefore possible to raise the jig 9 loaded on the stage 10a together with the core member 4 by the drive of the actuator 10b and to bring the core member 4 close to the surface material 3.

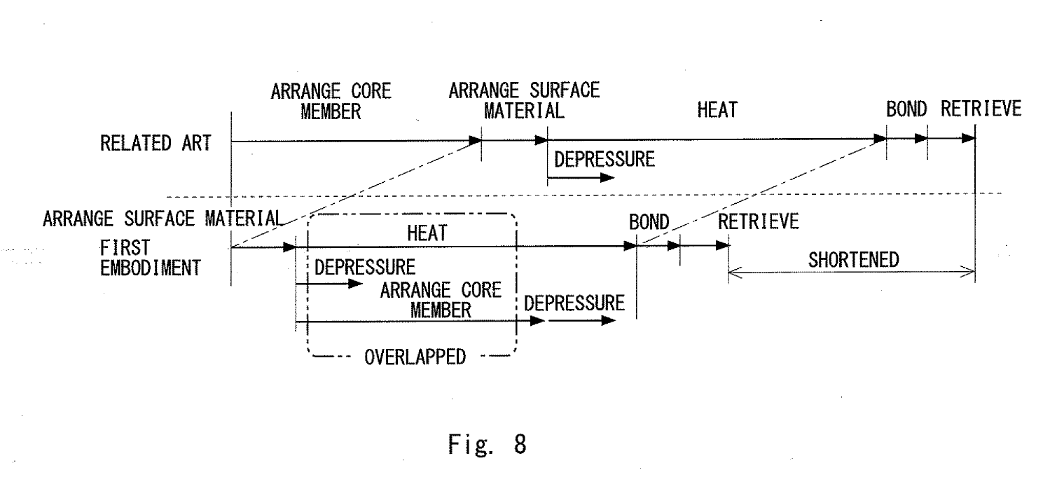

The composite material is manufactured as shown below using the manufacturing apparatus stated above. FIG. 8 shows in the lower part thereof a flow of the manufacturing method according to this embodiment. First, the surface material 3 is loaded on the upper surface of the frame member 7a and the surface material 3 is pressed by the pressing member 7b from above such that the part of the surface material 3 bonded to the core member 4 is exposed from the opening part 7c, the pressing member 7b is fixed to the frame member 7a by a clamp, and the surface material 3 is fixed by the frame member 7a and the pressing member 7b.

Next, as shown in FIG. 1, the first cover part 2a of the chamber box 2 is opened, and the surface material 3 fixed by the frame member 7a and the pressing member 7b is taken into the first space S1. The frame member 7a is supported by the support member 2d of the chamber box 2, and the first cover part 2a of the chamber box 2 is closed. At the same time, the second cover part 2b in the chamber box 2 is opened.

Next, as shown in FIG. 2, the space in the chamber box 2 is divided into the first space S1 and the second space S2 by the dividing unit 6. The surface material 3 is then heated from above and below the surface material 3 by the first heating part 8 and the second heating part 13 and the pump of the first pressure adjusting part is operated to evacuate gas from the first space 51, so as to depressurize the first space S1. At the same time, the jig 9 that supports the core member 4 is loaded on the stage 10a of the drive unit 10 by the transporting unit, and the core member 4 is arranged immediately below the surface material 3.

Next, as shown in FIG. 3, while the process for heating the surface material 3 and the process for depressurizing the first space S1 are continued, the second cover part 2b of the chamber box 2 is closed, and the pump of the second pressure adjusting part is operated to evacuate gas from the second space S2, thereby depressurizing the second space S2. As shown in FIG. 4, when both the first space S1 and the second space S2 are in a substantially vacuum state, the valves of the first and second pressure adjusting parts are closed. After that, the dividing unit 6 is slid and is contained in the third space S3 of the chamber box 2, thereby communicating the first space S1 with the second space S2. According to the above configuration, the whole of the chamber box 2 is brought to a substantially vacuum state.

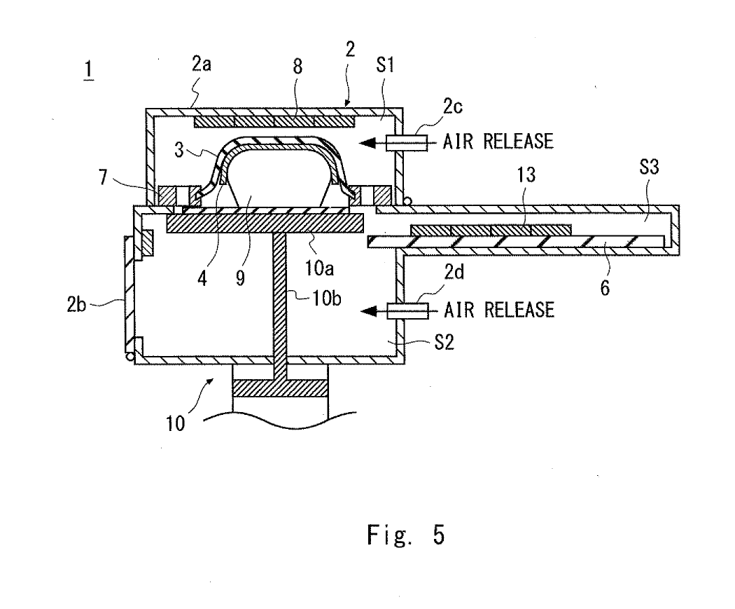

Next, as shown in FIG. 5, the stage 10a is raised by the actuator 10b and the surface material 3 is pressed against the predetermined part of the core member 4 from the opening part 7c of the frame member 7a to cover the predetermined part of the core member 4 with the surface material 3. At this time, the predetermined part of the core member 4 is covered with the surface material 3 under a substantially vacuum state, so that air bubbles do not penetrate between the surface material 3 and the core member 4.

The valves of the first and second pressure adjusting parts are opened to draw ambient air into the chamber box 2, and the pressure inside of the chamber box 2 is returned to atmospheric pressure to bond the surface material 3 to the predetermined part of the core member 4 so that the surface material 3 fits the predetermined part of the core member 4. Since the space in the chamber box 2 is pressurized to change from a substantially vacuum state to an atmospheric pressure state, the surface material 3 that is heated can be bonded to the predetermined part of the core member 4 so that the surface material 3 perfectly fits the predetermined part of the core member 4.

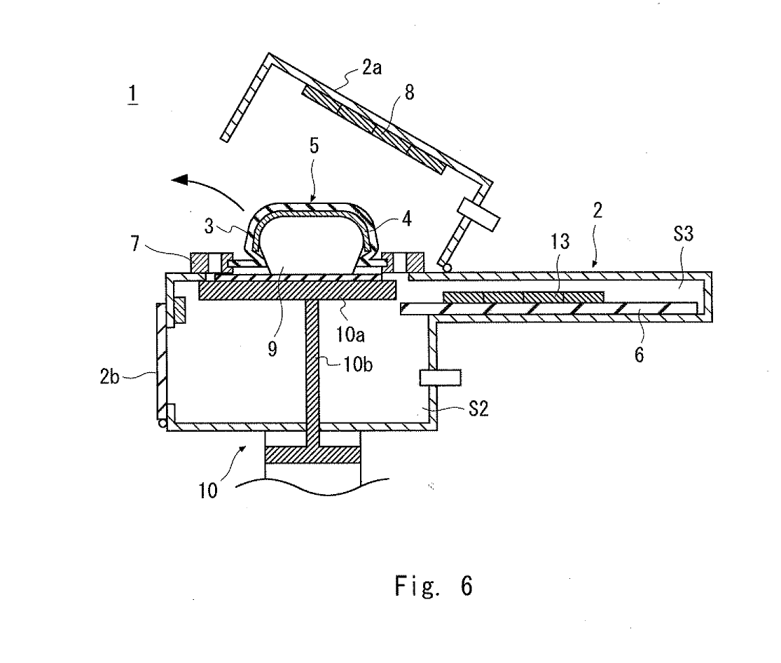

Lastly, as shown in FIG. 6, the first cover part 2a of the chamber box 2 is opened, the fixing of the surface material 3 by the fixing unit 7 is released, and the composite material 5 in which the surface material 3 is bonded to the predetermined part of the core member 4 is retrieved, whereby the manufacturing of the composite material 5 is completed.

With the manufacturing apparatus and the manufacturing method according to this embodiment, as shown in the lower part of FIG. 8, the process for heating the surface material 3 and the process for arranging the core member 4 can be overlapped in time. As will be clear from the comparison between the upper part of FIG. 8 showing the flow of the method for manufacturing the composite material according to the related art and the lower part of FIG. 8 showing the flow of the method for manufacturing the composite material according to this embodiment, it is possible to manufacture the composite material in a short period of time. In particular, the process for heating the surface material 3 and the process for arranging the core member 4 that are time-consuming processes can be overlapped in time when the composite material is manufactured, which can contribute to reducing the time for manufacturing the composite material.

Further, in this embodiment, the first space 51 is depressurized while the surface material 3 is heated. In summary, it is possible to have more time to produce a substantially vacuum state in the first space S1 than in the case in which the first space S1 is depressurized at the same time that the second space S2 is depressurized. It is therefore possible to reduce the size of the pump of the first pressure adjusting part and to form the first pressure adjusting part at a low cost. The first space S1 can also be depressurized at the same time that the second space S2 is depressurized.

### Second Embodiment

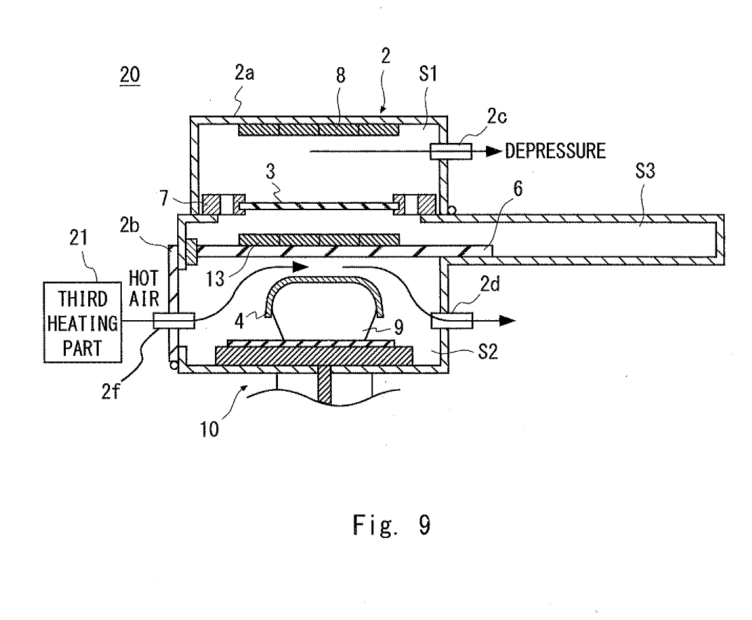

A manufacturing apparatus of a composite material according to this embodiment has such a configuration as to be able to further improve the adhesiveness between the surface material 3 and the core member 4. FIG. 9 is a schematic diagram showing one process for manufacturing the composite material using a manufacturing apparatus 20 according to this embodiment, and this process is performed, for example, between the process shown in FIG. 2 of the first embodiment and the process shown in FIG. 3 of the first embodiment. Since the configuration of the manufacturing apparatus 20 according to this embodiment is substantially similar to that of the manufacturing apparatus 1 according to the first embodiment, the overlapping description will be omitted and the members the same as those in the first embodiment are denoted by the same reference symbols.

As shown in FIG. 9, the manufacturing apparatus 20 includes a third heating part 21 to heat the core member 4. The third heating part 21 according to this embodiment feeds hot air to the second space S2 and sucks out gas in the second space S2. The third heating part 21 feeds, for example, hot air blown out by a blowout part to the second space S2 from an inlet 2f formed in the second cover part 2b of the chamber box 2 and sucks out gas from the second space S2 using the second pressure adjusting part.

It is therefore possible to heat the core member 4 and thus to further improve the adhesiveness between the surface material 3 and the core member 4. Further, the core member 4 can be heated while the surface material 3 is heated. According to such a structure, the time for manufacturing the composite material can be reduced.

Furthermore, since gas in the second space S2 is sucked out at the same time that hot air is fed to the second space S2, it is possible to take out dust and the like suspended in the second space S2 together with gas. According to the above configuration, hardly any dust penetrates between the surface material 3 and the core member 4, whereby it is possible to manufacture the composite material with high accuracy.

Furthermore, when the core member is heated in the conventional manufacturing apparatus, there is a difference between the pressure in the space between the core member and the surface material and the pressure in the space between the surface material and the upper lid, which may cause deformation of the surface material. In the manufacturing apparatus according to this embodiment, however, the core member 4 is heated after the space is divided into the first space S1 and the second space S2 by the dividing unit 6. There is thus no deformation in the surface material 3.

The configuration of the third heating part 21 is not limited to the above configuration and a heating part which is not formed to blow out hot air may be arranged in the second space S2, for example.

Note that the present invention is not limited to the above embodiments and may be changed as appropriate without departing from the spirit of the present invention.

For example, while the jig 9 is raised to press the core member 4 against the surface material 3 in the above embodiment, the fixing unit 7 may be lowered to press the surface material 3 against the core member 4.

For example, while adhesive is applied to the surface of the surface material 3 bonded to the core member 4 in the above embodiment, adhesive may be applied to the surface of the core member 4 bonded to the surface material 3.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A method for manufacturing a composite material by covering a core member with a surface material heated in a chamber box under reduced pressure, pressurizing the chamber box, and bonding the surface material to the core member, the method comprising the processes of:
arranging the surface material in the chamber box;
dividing the chamber box into a first space and a second space by closing a dividing unit, the first space including the surface material arranged therein and the second space including the core member arranged therein;
heating the surface material;
arranging the core member in the second space while the surface material is being heated;
depressurizing the first space in which the surface material is arranged and the second space in which the core member is arranged;
after the first space and the second space are depressurized, opening the dividing unit to make the first space communicate with the second space, arranging the core member and the surface material relatively close to each other, and covering a predetermined part of the core member with the surface material; and
after the predetermined part of the core member is covered with the surface material, pressurizing the chamber box to bond the surface material to the predetermined part of the core member so that the surface material fits the predetermined part of the core member.

2. The method for manufacturing the composite material according to claim 1, wherein depressurization of the first space is started while the surface material is being heated.

3. The method for manufacturing the composite material according to claim 1, comprising a process for heating the core member before the second space is depressurized.

4. An apparatus for manufacturing a composite material by covering a core member with a surface material heated in a chamber box under reduced pressure, pressurizing the chamber box, and bonding the surface material to the core member, the apparatus comprising:
a dividing unit that opens or closes a first communication path between a first space and a second space so that the chamber box can be divided into the first space and the second space, the first space containing the surface material and pressure in the first space being adjustable, the second space containing the core member and pressure in the second space being adjustable.

5. The apparatus for manufacturing the composite material according to claim 4, comprising:
a first heating part arranged in one side of the surface material in the first space; and
a second heating part arranged in the dividing unit and arranged in another side of the surface material in the first space in a state in which the dividing unit closes the first communication path,
wherein the surface material is heated by the first heating part and the second heating part from both sides of the surface material.

6. The apparatus for manufacturing the composite material according to claim 4, comprising:
a fixing unit arranged in the first space and fixing a circumferential edge of the surface material,
wherein the fixing unit comprises a second communication path that communicates one space and another space with the surface material interposed therebetween in the first space.

7. The apparatus for manufacturing the composite material according to claim 4, comprising a third heating part that heats the core member.

8. The apparatus for manufacturing the composite material according to claim 7, wherein the third heating part feeds hot air to the second space and sucks out gas in the second space.
